(19) United States
(12) Patent Application Publication
(10) Pub. No.: US 2024/0337747 A1
(43) Pub. Date: Oct. 10, 2024

(54) SENSOR APPARATUS WITH MULTIPLE SENSORS FOR MOVING AGENT

(71) Applicant: HUAWEI TECHNOLOGIES CO., LTD., Shenzhen (CN)

(72) Inventors: Moussab BENNEHAR, Boulogne Billancourt (FR); Dzmitry TSISHKOU, Boulogne Billancourt (FR); Nathan PIASCO, Boulogne Billancourt (FR)

(21) Appl. No.: 18/746,982

(22) Filed: Jun. 18, 2024

Related U.S. Application Data
(63) Continuation of application No. PCT/EP2021/087115, filed on Dec. 21, 2021.

(51) Int. Cl. G01S 17/86; G01P 21/00; G01S 7/497; G01S 17/87; G06T 7/73

(52) U.S. Cl. CPC G01S 17/86; G01P 21/00; G01S 7/497; G01S 17/87; G06T 7/73; G06T 2207/30244

(57) ABSTRACT

The present disclosure relates to a sensor apparatus for sensing data of an agent (for example a vehicle) performing a movement along an agent trajectory. An example sensor apparatus includes a motion sensor configured to obtain motion sensor data of the agent along the agent trajectory, a lidar sensor configured to obtain lidar data along the agent trajectory, and an imaging sensor configured to obtain image data along the agent trajectory. Furthermore, the sensor apparatus includes a processing circuitry configured to determine, based on the motion sensor data and the lidar data, a plurality of first poses of the lidar sensor along the agent trajectory and to determine, based on the motion sensor data and the image data, a plurality of second poses of the imaging sensor along the agent trajectory.

### CROSS-REFERENCE TO RELATED APPLICATIONS

This application is a continuation of International Application No. PCT/EP2021/087115, filed on Dec. 21, 2021, the disclosure of which is hereby incorporated by reference in its entirety.

### TECHNICAL FIELD

The present disclosure relates to sensing technology in general. More specifically, the disclosure relates to a sensor apparatus with multiple sensors for a moving agent, in particular a vehicle.

### BACKGROUND

Self-driving cars or cars with advanced driver assistance systems (ADAS) usually comprise a plurality of sensors for safely operating and navigating within their surrounding environment. These sensors, which often include lidar (light detection and ranging) sensors, imaging sensors, in particular cameras, and motion sensors, such as inertial measurement units (IMUs), may be used together in a synchronized way to achieve a complete coverage of the surrounding environment using sensor fusion techniques. However, in order to achieve the most accurate results using sensor fusion, the multiple sensors must be calibrated with respect to each other. Sensors intrinsic and extrinsic (spatial and temporal) calibration is essential for self-driving vehicles or ADASs for many tasks such as localization and perception, which are the backbone for other tasks, such as mapping, planning, control and the like. For instance, visual inertial odometry (VIO) algorithms rely on the accuracy of the calibration between a motion sensor and an imaging sensor to provide accurate motion estimation. Multi-sensor calibration is a relatively complex task since it involves different types of measured data, such as image data, point cloud data, the like, obtained at different sampling rates. The main objective of multi-sensor calibration is to determine the spatial relationships between the sensors, i.e. the relative orientations and positions between the multiple sensors.

### SUMMARY

It is an object to provide an improved sensor apparatus with multiple sensors.

The foregoing and other objects are achieved by the subject matter of the independent claims. Further implementation forms are apparent from the dependent claims, the description and the figures.

According to a first aspect a sensor apparatus for sensing data of an agent performing a movement along an agent trajectory is provided. The agent may be a vehicle performing a movement along the agent trajectory. The agent trajectory may be defined by a plurality of poses, i.e. positions and orientations (also referred to as rotations) in three-dimensional space as a function of time.

The sensor apparatus comprises a motion sensor configured to obtain motion sensor data of the agent along the agent trajectory, a lidar sensor configured to obtain lidar data along the agent trajectory, and an imaging sensor configured to obtain image data along the agent trajectory. The imaging sensor may be, for instance, a camera.

The sensor apparatus further comprises a processing circuitry configured to determine based on the motion sensor data and the lidar data a plurality of first poses of the lidar sensor along the agent trajectory. The plurality of first poses of the lidar sensor may be determined along the agent trajectory relative to a reference frame of the lidar sensor. The processing circuitry is further configured to determine based on the motion sensor data and the image data a plurality of second poses of the imaging sensor along the agent trajectory. The plurality of second poses of the imaging sensor may be determined along the agent trajectory relative to a reference frame of the imaging sensor (which usually may differ from, i.e. may be rotated and/or translated relative to the reference frame of the lidar sensor). Moreover, the processing circuitry is configured to determine, based on the plurality of first poses and the plurality of second poses along the agent trajectory, a pose of the lidar sensor and a pose of the imaging sensor relative to the motion sensor. By determining the pose of the lidar sensor and the pose of the imaging sensor relative to the motion sensor, a position and an orientation, i.e. a pose of the lidar sensor relative to the imaging sensor may be determined.

The sensor apparatus according to the first aspect implements an automated targetless calibration scheme for its multiple sensors. Using the motion sensor as the main calibration sensor allows for a better motion estimation and removing distortion from the lidar data. The calibration scheme implemented by the sensor apparatus according to the first aspect may be scaled to any number of sensors in a computationally efficient way. As the motion sensor is used as the main calibration source, the calibration (or a recalibration) can be performed while the agent, in particular the vehicle is operating, i.e. moving. In other words, it is not necessary to immobilize the agent, e.g. vehicle to redo the calibration.

In a further possible implementation form, the motion sensor comprises an accelerometer and/or a gyroscope and the motion sensor data comprises data about linear accelerations and/or rotational motions of the motion sensor along the agent trajectory.

In a further possible implementation form, the processing circuitry is configured to determine, based on the motion sensor data and the lidar data, the plurality of first poses of the lidar sensor along the agent trajectory using a continuous-time batch optimization scheme.

In a further possible implementation form, the processing circuitry is configured to represent the plurality of first poses of the lidar sensor along the agent trajectory as a continuous time function. The continuous time function may map a respective point in time to a point in three-dimensional space.

In a further possible implementation form, the processing circuitry is configured to determine based on the motion sensor data and the image data the plurality of second poses of the imaging sensor along the agent trajectory using a continuous-time batch optimization scheme.

In a further possible implementation form, the processing circuitry is configured to represent the plurality of second poses of the imaging sensor along the agent trajectory as a continuous time function.

In a further possible implementation form, the processing circuitry is further configured to determine a difference measure value between the first plurality of poses and the second plurality of poses and to determine, based on the plurality of first poses and the plurality of second poses along the agent trajectory, the pose of the lidar sensor and the pose of the imaging sensor relative to the motion sensor, if the difference measure value is smaller than a threshold value. By determining the pose of the lidar sensor and the pose of the imaging sensor relative to the motion sensor, the processing circuitry may further determine the position and the orientation, i.e. the pose of the lidar sensor relative to the imaging sensor.

In a further possible implementation form, the sensor apparatus comprises a plurality of lidar sensors configured to obtain lidar data along the agent trajectory and/or a plurality of imaging sensors configured to obtain image data along the agent trajectory.

In a further possible implementation form, the processing circuitry is configured, for respective sensor pairs of the plurality lidar sensors and/or the plurality of imaging sensors, determine, based on the plurality of respective first poses and the plurality of respective second poses along the agent trajectory, a respective pose of the respective lidar sensor and a respective pose of the respective imaging sensor relative to the motion sensor. This may be continued for respective pairs of sensors.

According to a second aspect an advanced driver assistance system (ADAS) comprising a sensor apparatus according to the first aspect is provided.

According to a third aspect a vehicle comprising a sensor apparatus according to the first aspect and/or an ADAS according to the second aspect is provided.

According to a fourth aspect a method for sensing data of an agent performing a movement along an agent trajectory is provided. The method comprises the steps of:
obtaining by a motion sensor motion sensor data along the agent trajectory;
obtaining by a lidar sensor lidar data along the agent trajectory;
obtaining by an imaging sensor image data along the agent trajectory;
determining based on the motion sensor data and the lidar data a plurality of first poses of the lidar sensor along the agent trajectory;
determining based on the motion sensor data and the image data a plurality of second poses of the imaging sensor along the agent trajectory; and
determining, based on the plurality of first poses and the plurality of second poses along the agent trajectory, a pose of the lidar sensor and a pose of the imaging sensor relative to the motion sensor.

The method according to the fourth aspect of the present disclosure can be performed by the sensor apparatus according to the first aspect of the present disclosure. Thus, further features of the method according to the fourth aspect of the present disclosure result directly from the functionality of the sensor apparatus according to the first aspect of the present disclosure as well as its different implementation forms described above and below.

According to a fifth aspect a computer program product is provided, comprising a computer-readable storage medium for storing program code which causes a computer or a processor to perform the method according to the fourth aspect, when the program code is executed by the computer or the processor.

Details of one or more embodiments are set forth in the accompanying drawings and the description below. Other features, objects, and advantages will be apparent from the description, drawings, and claims.

### BRIEF DESCRIPTION OF THE DRAWINGS

In the following embodiments of the invention are described in more detail with reference to the attached figures and drawings, in which:

FIG. 1 is a schematic diagram illustrating a sensor apparatus according to an embodiment;

FIG. 2 shows a recalibration performed by the sensor apparatus of FIG. 1;

FIG. 3 is a diagram illustrating a calibration scheme implemented by the sensor apparatus according to an embodiment for calibrating multiple sensor pairs;

FIG. 4 is a schematic diagram of an advanced driver assistance system according to an embodiment comprising a sensor apparatus according to an embodiment;

FIG. 5 is a schematic diagram of a vehicle according to an embodiment comprising a sensor apparatus according to an embodiment;

FIG. 6 shows a flow diagram illustrating steps of a method of sensing data according to an embodiment;

FIG. 7 is a diagram illustrating an exemplary trajectory of a vehicle according to an embodiment comprising a sensor apparatus according to an embodiment; and

FIGS. 8a and 8b shows graphs illustrating exemplary aligned sensor trajectories for a sensor apparatus according to an embodiment for two different scenarios.

In the following identical reference signs refer to identical or at least functionally equivalent features.

### DETAILED DESCRIPTION OF THE EMBODIMENTS

In the following description, reference is made to the accompanying figures, which form part of the disclosure, and which show, by way of illustration, specific aspects of embodiments of the invention or specific aspects in which embodiments of the present invention may be used. It is understood that embodiments of the invention may be used in other aspects and comprise structural or logical changes not depicted in the figures. The following detailed description, therefore, is not to be taken in a limiting sense, and the scope of the present invention is defined by the appended claims.

For instance, it is to be understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

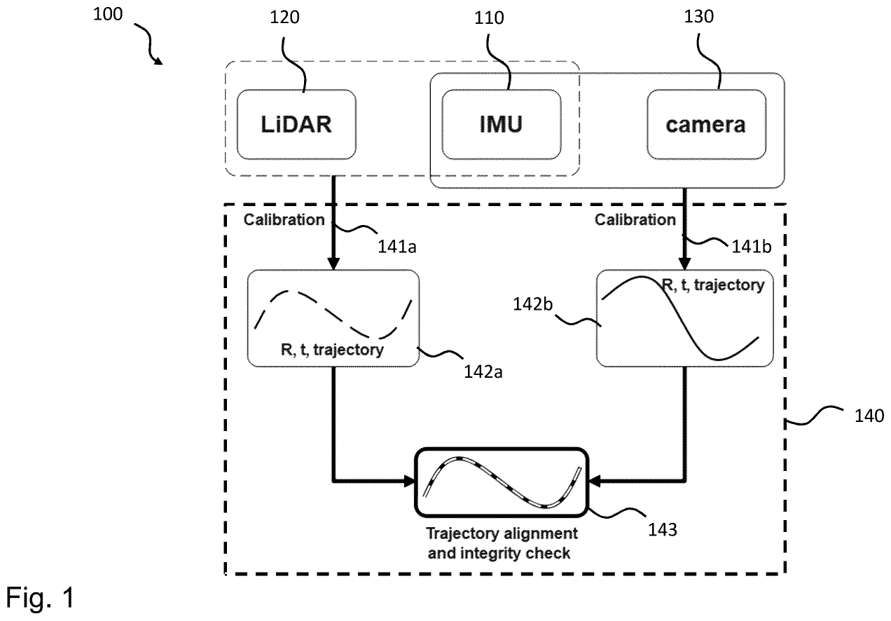

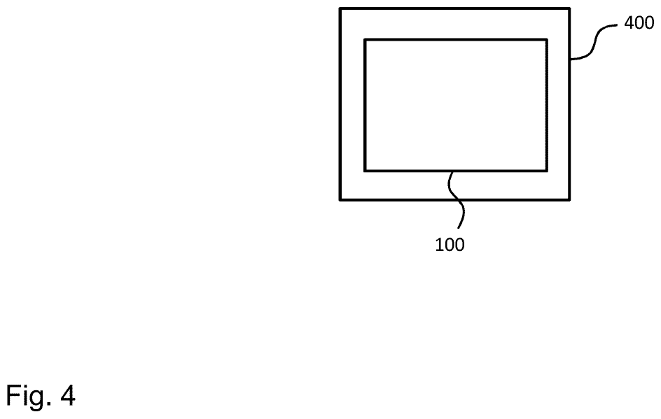

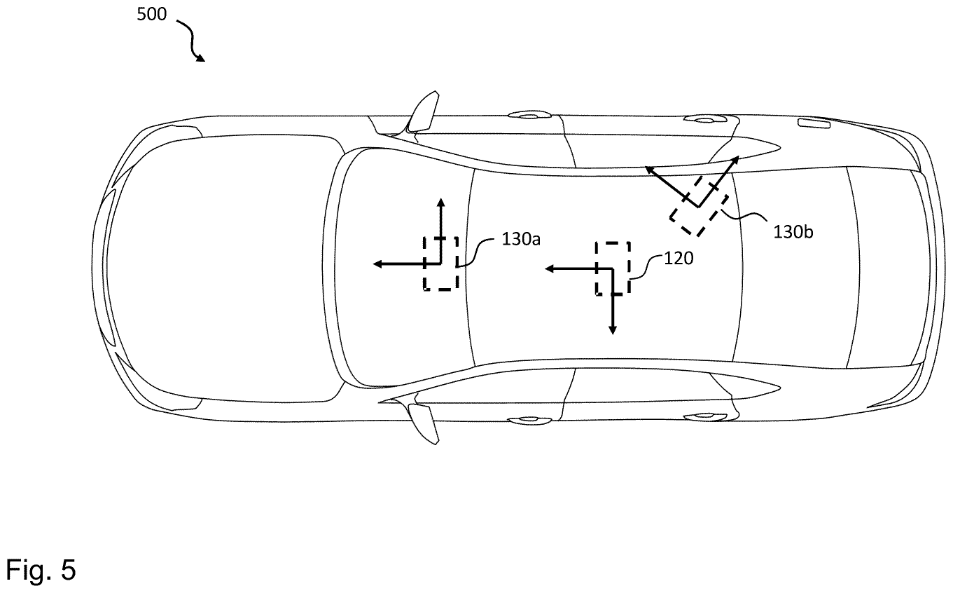

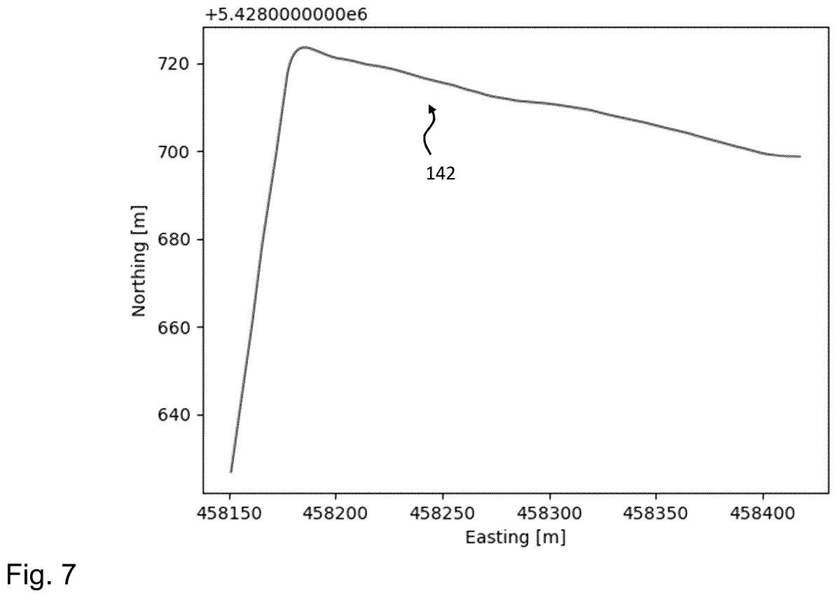

FIG. 1 is a schematic diagram illustrating a sensor apparatus 100 according to an embodiment. As will be described in more detail below, the sensor apparatus may be part of an advanced driver assistance system 400 (shown in FIG. 4) and/or of a vehicle 500 (shown in FIG. 5). The sensor apparatus 100 is configured to sense data of the vehicle performing a movement along a vehicle trajectory. An exemplary trajectory 142 of the vehicle 500 is shown in FIG. 7.

As illustrated in FIG. 1, the sensor apparatus 100 comprises at least one motion sensor 110 configured to obtain motion sensor data of the vehicle 500 along the vehicle trajectory 142. In an embodiment, the at least one motion sensor 110 may comprise an accelerometer, a gyroscope and/or an inertial measurement unit (IMU) and the motion sensor data may comprise data about linear accelerations and/or rotational motions of the motion sensor 110 along the vehicle trajectory 142. The sensor apparatus 100 further comprises at least one lidar sensor 120 configured to obtain lidar data along the vehicle trajectory 142 and at least one imaging sensor 130, for instance, a camera 130 configured to obtain image data along the vehicle trajectory 142.

The sensor apparatus further comprises a processing circuitry 140 configured to determine based on the motion sensor data and the lidar data a plurality of first poses of the lidar sensor 120 along the vehicle trajectory 142 and to determine based on the motion sensor data and the image data a plurality of second poses of the imaging sensor 130 along the vehicle trajectory 142. As will be described in more detail below, the processing circuitry 140 of the sensor apparatus 100 is further configured to determine, based on the plurality of first poses and the plurality of second poses along the agent trajectory, a pose of the lidar sensor 120 and a pose of the imaging sensor 130 relative to the motion sensor 110. The processing circuitry 140 of the sensor apparatus 100 may be implemented in hardware and/or software and may comprise digital circuitry, or both analog and digital circuitry. Digital circuitry may comprise components such as application-specific integrated circuits (ASICs), field-programmable arrays (FPGAs), digital signal processors (DSPs), or general-purpose processors.

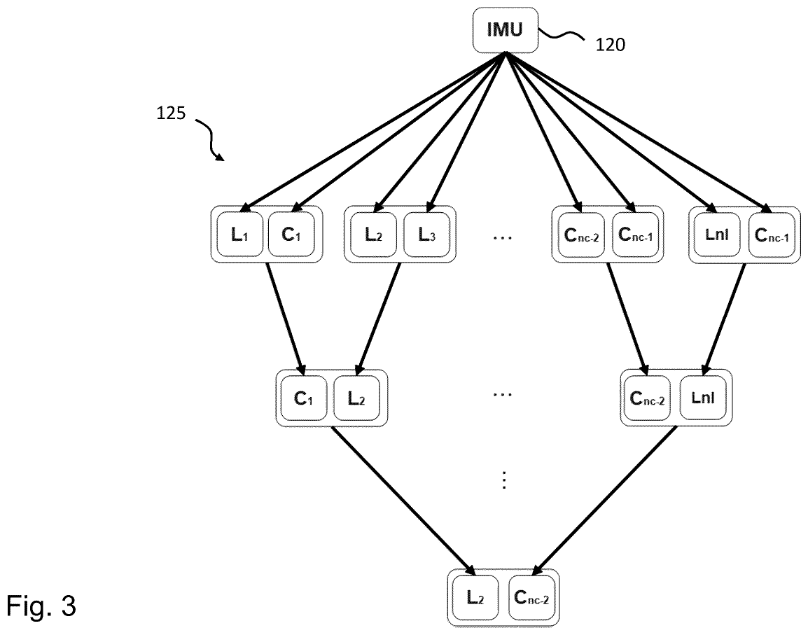

As will be appreciated, the sensor apparatus 100 makes use of the motion sensor data provided by the motion sensor for calibrating the lidar sensor 120 and the imaging sensor 130, i.e. for determining the trajectory of the lidar sensor 120 and the imaging sensor 130 in a common reference frame. In an embodiment, where the sensor apparatus 100 comprises more than one lidar sensor 120 and/or more than one imaging sensor 130, the calibrating may be performed based on a plurality of pairs 125 of these sensors 120, 130 (as illustrated in FIG. 3) for estimate the trajectory of each sensor 120, 130 individually and, subsequently, validate the integrity of the full sensor system by means of pairwise comparison of sensors trajectories after aligning them into the common reference frame, such as a reference frame defined by the vehicle 500 and/or the motion sensor 110.

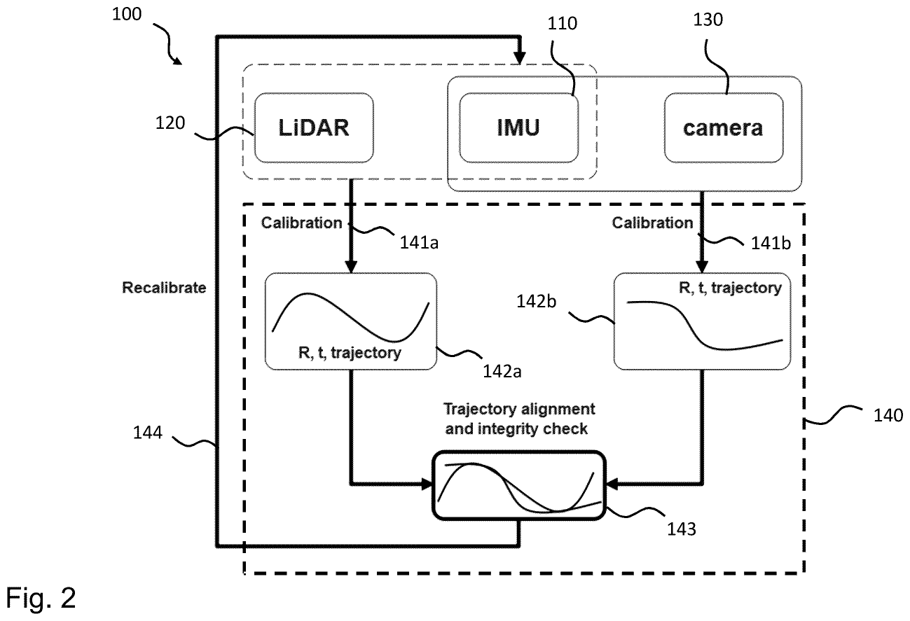

As illustrated in FIGS. 1 and 2, the calibration scheme implemented by the sensor apparatus 100 according to an embodiment can be split into two stages, namely a first stage of separately calibrating the lidar sensor 120 with the motion sensor 110 and the imaging sensor 130 with the motion sensor 110 and a second stage of alignment of trajectories and multi-sensor calibration integrity validation.

In the first stage the sensor apparatus 100 starts the calibration process by triggering the motion sensor(s) 110, the lidar sensor(s) 120 and the imaging sensor(s) 130 to collect data. In an embodiment, the motion sensor data may comprise data about linear accelerations and/or rotational motions of the motion sensor 110 along the vehicle trajectory 142 collected with a rate of, for instance, 100 Hz or larger. In an embodiment, this rate is higher than the data acquisition rates of the lidar sensor(s) 120 and/or the imaging sensor(s) 130. In an embodiment, the image data provided by the imaging sensor 130 may comprise a plurality of image frames provided with a rate of, for instance, at least 25 frames per second and an image resolution of, for instance, at least 1080p. In an embodiment, the lidar data provided by the lidar sensor(s) 120 may be provided in the form of a point cloud. In an embodiment, where the lidar sensor(s) comprises a rotary lidar sensor 120 the point cloud may be based on, for instance, at least 16 scan layers of the rotary lidar sensor 120. In an embodiment, the points of the point cloud may further comprise timestamp information.

As already described above, based on these data the processing circuitry 140 is configured to calibrate each pair of motion sensor 110 and lidar sensor 120 and each pair of motion sensor 110 and imaging sensor 130 of the sensor apparatus 100. After pairwise calibration is successfully completed for each sensor pair 125, the processing circuitry 140 validates the integrity of the calibration, i.e. verifies that the obtained calibration parameters and sensor trajectories are consistent for all sensors.

To this end, as already described above, all lidar sensors 120 and imaging sensors 130 may be grouped into pairs 125. The processing circuitry 140 may map their trajectories obtained during calibration into the common reference frame. Since, in an embodiment, a continuous-time representation of those trajectories may be used, the processing circuitry 140 may be configured to compare trajectory poses for both sensors of a pair to obtain an alignment score. If the calibration is consistent, there should be no or only a small alignment error. Otherwise, the processing circuitry 140 may perform a recalibration as illustrated in FIG. 2.

Given that each pair 125 of the previously grouped sensors illustrated in FIG. 3 is correctly calibrated, the processing circuitry 140 may then randomly select one sensor from each pair and, again, group those randomly selected sensors into pairs and perform the calibration integrity check again. This process may be repeated by the processing circuitry 140 until only two sensors are left, as illustrated in FIG. 3, and their alignment error is smaller than the specified error threshold.

As already described above, embodiments of the sensor apparatus 100 are based on the idea to split the calibration of a multi-sensor setup into multiple pairwise calibration subsystems using the motion sensor(s) 110, the lidar sensor(s) 120 and the imaging sensor(s) 130. FIG. 1 illustrates the pairwise calibration process in the simple case of one motion sensor 110, one lidar sensor 120 and one imaging sensor 130.

In an embodiment, for the calibration between the motion sensor 110 and the imaging sensor 130 the processing circuitry 140 may use a continuous-time batch optimization scheme. An example for such a continuous-time batch optimization scheme is disclosed in P. Furgale, T. D. Barfoot, and G. Sibley, “Continuous-time batch estimation using temporal basis functions,” 2012 IEEE International Conference on Robotics and Automation, May 2012, pp. 2088-2095), which is fully incorporated herein by reference. In an embodiment, the processing circuitry 130 may use a continuous-time representation of the trajectory of the imaging sensor 130. In an embodiment, the output of the continuous-time batch optimization scheme implemented by the processing circuitry 140 may be the trajectory of the imaging sensor 130 in continuous form (i.e. based on temporal basis functions) and a transformation matrix from the motion sensor reference frame to the imagining sensor reference frame.

Likewise, in an embodiment, for the calibration between the motion sensor 110 and the lidar sensor 120 the processing circuitry 140 may use a continuous-time batch optimization scheme. In an embodiment, the output of the continuous-time batch optimization scheme implemented by the processing circuitry 140 may be the trajectory of the lidar sensor 120 in continuous form (i.e. based on temporal basis functions) and a transformation matrix from the motion sensor reference frame to the lidar sensor reference frame.

After the calibration parameters 141a, 141b and the trajectories 142a, 142b have been determined by the processing circuitry 140, the processing circuitry 140 may proceed in a stage 143 with aligning the two trajectories using the calibration transformation matrix. Aligning the two trajectories obtained from separate calibrations described above, allows the processing circuitry to estimate an alignment error. In the case of a successful calibration, all the transformation relationships between the three sensors 110, 120, 130 are available. If however the trajectories are not well aligned (i.e. there is a large alignment error, as illustrated in FIG. 2), the processing circuitry 140 is configured to trigger a recalibration loop 144.

As already described above, the calibration scheme illustrated in FIGS. 1 and 2 for the exemplary embodiment of the sensor apparatus having a single motion sensor 110, a single lidar sensor 120 and a single imaging sensor 130 can be generalized to multiple sensors, e.g. multiple lidar sensors 120 and/or multiple imaging sensors 130. For such an embodiment, as illustrated in FIG. 3, the processing circuitry 140 may perform the same pairwise calibration for each pair 125 of motion sensor 110 and imaging sensor 130 and for each pair 125 of motion sensor 110 and lidar sensor 120 separately. This results in a respective continuous-time trajectory of the imaging sensor 130 and the lidar sensor 120 in its own frame. As illustrated in FIG. 3, the processing circuitry 140 may then group the set of lidar sensors 120 and imagining sensors 130 into pairs 125 and validate their calibration in the same way as for the embodiment described above. If a pair 125 of sensors is not calibrated (because of a large alignment error), the same recalibration loop as described above may be applied, until all sensor pairs 125 are accurately calibrated together. In a further stage the processing circuitry 140 may randomly select one sensor from the sensor pairs 125 used for integrity verification and use it with another randomly selected sensor for again checking the calibration accuracy. This process may be repeated until only two pairs of sensors are left and their calibration consistency is validated, as illustrated in FIG. 3.

FIG. 4 shows a schematic diagram of an advanced driver assistance system, ADAS, 400 according to an embodiment comprising the sensor apparatus 100 according to an embodiment.

FIG. 5 shows a top view of a vehicle, in particular a car 500 according to an embodiment comprising the sensor apparatus 100 according to an embodiment. In the embodiment shown in FIG. 5, the sensor apparatus 100 of the car 500 comprises, by way of example, one lidar sensor 120 with a lidar sensor reference frame (illustrated by the arrows), and two imaging sensors 130a, 130a having a respective imaging sensor reference frame (illustrated by the arrows).

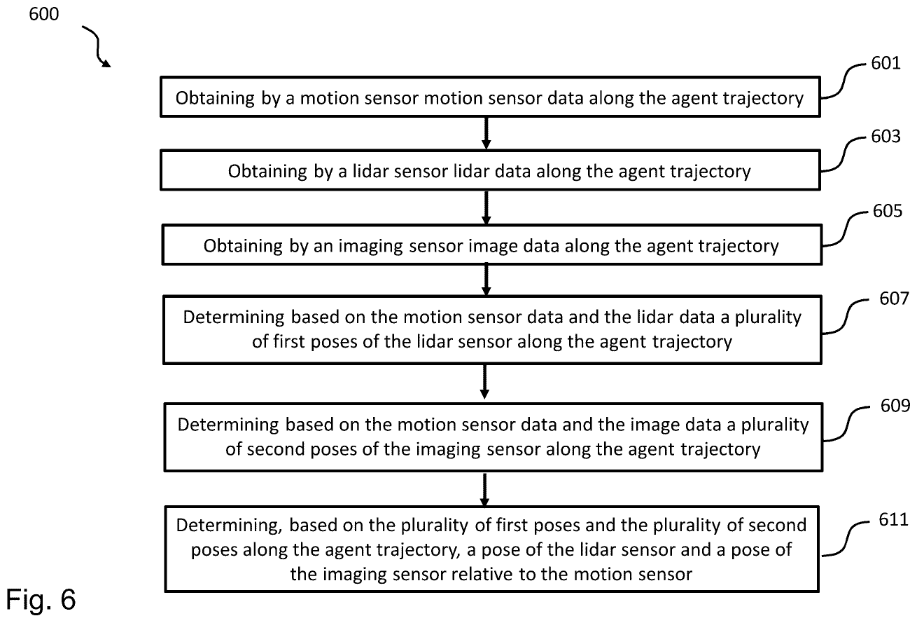

FIG. 6 shows a flow diagram illustrating a method 600 for sensing data of the agent, e.g. vehicle 500 performing a movement along an agent trajectory. The method 600 comprises the steps of:
obtaining 601 by the motion sensor 100 motion sensor data along the agent trajectory;
obtaining 603 by the lidar sensor 120 lidar data along the agent trajectory;
obtaining 605 by the imaging sensor 130 image data along the agent trajectory;
determining 607 based on the motion sensor data and the lidar data a plurality of first poses of the lidar sensor 120 along the agent trajectory;
determining 609 based on the motion sensor data and the image data a plurality of second poses of the imaging sensor 130 along the agent trajectory; and
determining, based on the plurality of first poses and the plurality of second poses along the agent trajectory, a pose of the lidar sensor 120 and a pose of the imaging sensor 130 relative to the motion sensor 110.

Although the steps 603, 605 are illustrated in FIG. 6 after the step 601, it will be appreciated that the steps 601, 603 and 605 may occur in an overlapping manner, substantially at the same time or in a different order. In other words, the motion sensor data, the lidar data and the image data may be collected, i.e. obtained substantially simultaneously while the agent, e.g. vehicle 500 is moving along its trajectory.

As will be appreciated, instead of combining all data in a single bulky calibration process, embodiments of the sensor apparatus 100 disclosed herein allow splitting it into small pairwise calibration processes. This allows to simplify the computation complexity of the whole process and to easily be able to detect calibration failures due to sensor anomalies. Moreover, the use of continuous-time representation of the sensors trajectories also provides a better accuracy for the consistency validation of the calibration results and the respective sensor pose may be queried at any time. Considering that sensors usually operate with different frequencies/rates this becomes very important to have accurate correspondences between the two trajectories.

As the motion sensor 130 may have a high data bandwidth or data rate, it is very suitable for a continuous-time batch optimization technique as they allow to get accurate calibration and motion estimation results. Using the motion sensor 110 to calibrate the imaging sensor 130 allows obtaining up-to-scale motion of the imaging sensor 130. Using the motion sensor 110 to calibrate the lidar sensor 120 allows removing distortion from the point cloud provided by the lidar sensor 120 and accurately estimating the motion on a frame-to-frame basis.

As already described above, the calibration scheme implemented by the sensor apparatus 100 according to an embodiment does not require any targets (i.e. targetless). Moreover, as the calibration scheme implemented by the sensor apparatus 100 according to an embodiment does not require the agent, e.g. vehicle 500 to stand still, it is very suitable for online calibration, online recalibration and detection of calibration issues. With all the sensors 110, 120, 130 being calibrated, a process may be implemented by the processing circuitry 140 of the sensor apparatus 100 that gets triggered periodically under the condition that the agent, e.g. vehicle 500 is not static to be able to recover its trajectory necessary for pairwise calibration. Once data is collected between a starting and ending timestamp, the trajectory of each sensor may be obtained by motion estimation using the respective sensor pair. The necessary transformations may be applied using known calibration parameters to express all the recovered trajectories in the common reference frame, e.g. the reference frame of the motion sensor 110 and/or the vehicle 600. Pairwise calibration integrity verification similar to the previous section may be used to validate that calibration is still valid. If the calibration is no longer valid, the calibration loop may be re-run again with the previously known transformations to get better recalibration and faster convergence.

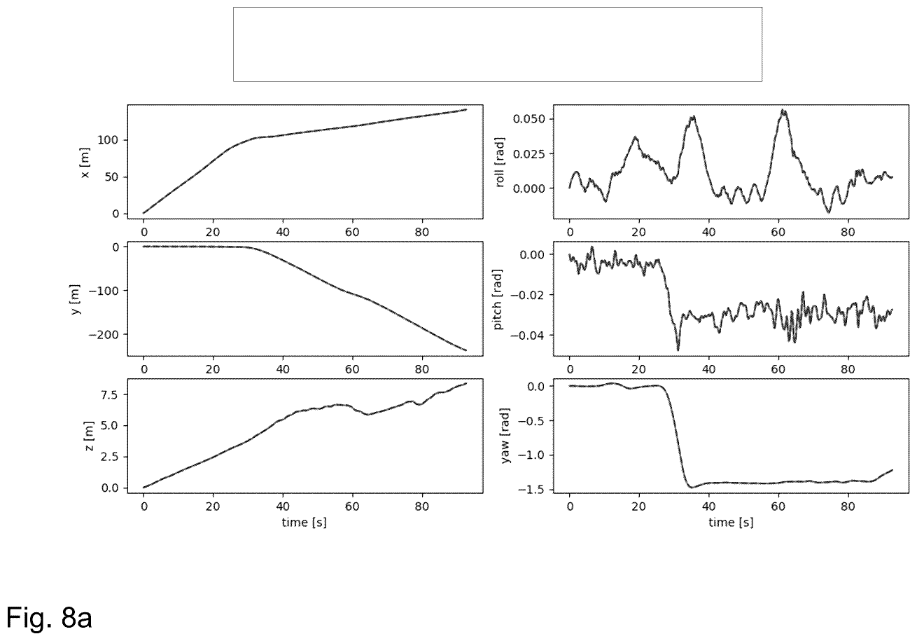

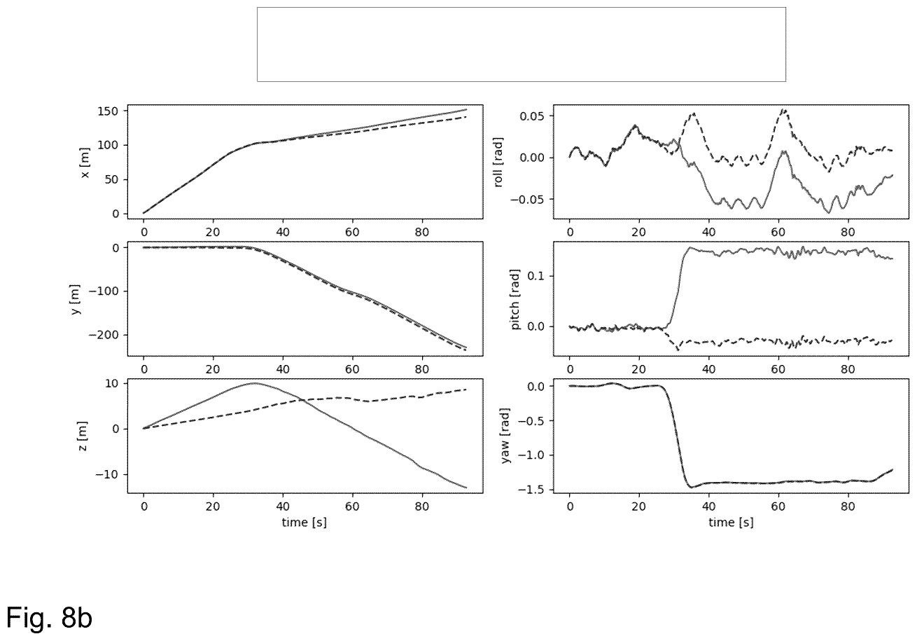

For estimating the performance of the calibration scheme implemented by the sensor apparatus 100 according to an embodiment the recorded data obtained by the car 500 illustrated in FIG. 5 with one lidar sensor 120 and two imaging sensors 130a, 130b has been used. The exemplary trajectory of the car 500 in UTM coordinates is shown in FIG. 7. The trajectories of each sensor 120, 130a, 130b in its own frame are obtained by the motion-estimation-based calibration process implemented by the sensor apparatus 100 described above. As described above, based on each sensor trajectory and the calibration data, those trajectories are mapped to the common reference frame, e.g. the reference frame of the motion sensor 110 and/or the reference frame of the car 500 to validate the success of the calibration process. A successful calibration would result in well aligned trajectories. This scenario is illustrated in FIG. 8a, where the trajectories are well aligned after expressing them in the common reference frame (not discernible distinction between the dashed and the solid curves. In the case, where the calibration process was not successful, this may be caused by sensor data not suitable for calibration due to, for instance, sensor anomalies, which does not enable to successfully align the three trajectories. This scenario is illustrated in FIG. 8b, where the trajectories of one of the imagining sensors 130a (referred to as front camera in FIGS. 8a and 8b; dashed lines) and the lidar sensor 120 (solid lines) do not align well.

Although embodiments of the sensor apparatus 100 have been described above mainly in the context of a vehicle, such as the car 500 shown in FIG. 5, it will be appreciated that the sensor apparatus 100 may be used for other types of moving agents as well, such as mobile robotics, flying robots, handheld mapping systems, and the like.

The person skilled in the art will understand that the “blocks” (“units”) of the various figures (method and apparatus) represent or describe functionalities of embodiments (rather than necessarily individual “units” in hardware or software) and thus describe equally functions or features of apparatus embodiments as well as method embodiments (unit=step).

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments may be integrated into one processing unit, or each of the units may exist alone physically, or two or more units are integrated into one unit.

1. A sensor apparatus for sensing data of an agent performing a movement along an agent trajectory, wherein the sensor apparatus comprises:
a motion sensor configured to obtain motion sensor data of the agent along the agent trajectory;
a lidar sensor configured to obtain lidar data along the agent trajectory;
an imaging sensor configured to obtain image data along the agent trajectory; and
a processing circuitry configured to:
determine, based on the motion sensor data and the lidar data, a plurality of first poses of the lidar sensor along the agent trajectory;
determine, based on the motion sensor data and the image data, a plurality of second poses of the imaging sensor along the agent trajectory; and
determine, based on the plurality of first poses and the plurality of second poses along the agent trajectory, a pose of the lidar sensor and a pose of the imaging sensor relative to the motion sensor.

2. The sensor apparatus of claim 1, wherein the motion sensor comprises at least one of an accelerometer or a gyroscope, and wherein the motion sensor data comprises data about at least one of linear accelerations or rotational motions of the motion sensor along the agent trajectory.

3. The sensor apparatus of claim 1, wherein the imaging sensor comprises a camera.

4. The sensor apparatus of claim 1, wherein the processing circuitry is configured to determine, based on the motion sensor data and the lidar data, the plurality of first poses of the lidar sensor along the agent trajectory using a continuous-time batch optimization scheme.

5. The sensor apparatus of claim 4, wherein the processing circuitry is configured to represent the plurality of first poses of the lidar sensor along the agent trajectory as a continuous time function.

6. The sensor apparatus of claim 1, wherein the processing circuitry is configured to determine, based on the motion sensor data and the image data, the plurality of second poses of the imaging sensor along the agent trajectory using a continuous-time batch optimization scheme.

7. The sensor apparatus of claim 6, wherein the processing circuitry is configured to represent the plurality of second poses of the imaging sensor along the agent trajectory as a continuous time function.

8. The sensor apparatus of claim 1, wherein the processing circuitry is further configured to determine a difference measure value between the plurality of first poses and the plurality of second poses and to determine, based on the plurality of first poses and the plurality of second poses along the agent trajectory, the pose of the lidar sensor and the pose of the imaging sensor relative to the motion sensor, in response to determining that the difference measure value is smaller than a threshold value.

9. The sensor apparatus of claim 1, wherein the sensor apparatus comprises at least one of a plurality of lidar sensors configured to obtain lidar data along the agent trajectory or a plurality of imaging sensors configured to obtain image data along the agent trajectory.

10. The sensor apparatus of claim 9, wherein the processing circuitry is configured, for respective sensor pairs of the at least one of the plurality of lidar sensors or the plurality of imaging sensors, to determine, based on a plurality of respective first poses and a plurality of respective second poses along the agent trajectory, a respective pose of a respective lidar sensor and a respective pose of a respective imaging sensor relative to the motion sensor.

11. A vehicle comprising a sensor apparatus for sensing data of an agent performing a movement along an agent trajectory, wherein the sensor apparatus comprises:
a motion sensor configured to obtain motion sensor data of the agent along the agent trajectory;
a lidar sensor configured to obtain lidar data along the agent trajectory;
an imaging sensor configured to obtain image data along the agent trajectory; and
a processing circuitry configured to:
determine, based on the motion sensor data and the lidar data, a plurality of first poses of the lidar sensor along the agent trajectory;
determine, based on the motion sensor data and the image data, a plurality of second poses of the imaging sensor along the agent trajectory; and
determine, based on the plurality of first poses and the plurality of second poses along the agent trajectory, a pose of the lidar sensor and a pose of the imaging sensor relative to the motion sensor.

12. The vehicle of claim 11, wherein the motion sensor comprises at least one of an accelerometer or a gyroscope, and wherein the motion sensor data comprises data about at least one of linear accelerations or rotational motions of the motion sensor along the agent trajectory.

13. The vehicle of claim 11, wherein the imaging sensor comprises a camera.

14. The vehicle of claim 11, wherein the processing circuitry is configured to determine, based on the motion sensor data and the lidar data, the plurality of first poses of the lidar sensor along the agent trajectory using a continuous-time batch optimization scheme.

15. The vehicle of claim 14, wherein the processing circuitry is configured to represent the plurality of first poses of the lidar sensor along the agent trajectory as a continuous time function.

16. A method for sensing data of an agent performing a movement along an agent trajectory, wherein the method comprises:
obtaining, by a motion sensor, motion sensor data along the agent trajectory;
obtaining, by a lidar sensor, lidar data along the agent trajectory;
obtaining, by an imaging sensor, image data along the agent trajectory;
determining, based on the motion sensor data and the lidar data, a plurality of first poses of the lidar sensor along the agent trajectory;
determining, based on the motion sensor data and the image data, a plurality of second poses of the imaging sensor along the agent trajectory; and
determining, based on the plurality of first poses and the plurality of second poses along the agent trajectory, a pose of the lidar sensor and a pose of the imaging sensor relative to the motion sensor.

17. The method of claim 16, wherein the plurality of first poses of the lidar sensor along the agent trajectory is determined using a continuous-time batch optimization scheme.

18. The method of claim 17, further comprising representing the plurality of first poses of the lidar sensor along the agent trajectory as a continuous time function.

19. The method of claim 16, wherein the plurality of second poses of the imaging sensor along the agent trajectory is determined using a continuous-time batch optimization scheme.

20. The method of claim 19, further comprising representing the plurality of second poses of the imaging sensor along the agent trajectory as a continuous time function.
